(19) United States
(12) Patent Application Publication
(10) Pub. No.: US 2022/0051280 A1
(43) Pub. Date: Feb. 17, 2022

(54) DYNAMIC CUSTOMER RE-ENGAGEMENT MECHANISM

(71) Applicant: INTERNATIONAL BUSINESS MACHINES CORPORATION, ARMONK, NY (US)

(72) Inventors: Shikhar Kwatra, Raleigh, NC (US); Jeremy R. Fox, Georgetown, TX (US); Sarbajit K. Rakshit, Kolkata (IN); Zachary A. Silverstein, Jacksonville, FL (US)

(21) Appl. No.: 16/947,670

(22) Filed: Aug. 12, 2020

(51) Int. Cl. G06Q 30/02; G06Q 30/06

(52) U.S. Cl. CPC G06Q 30/0224; G06Q 30/0611

(57) ABSTRACT

A method comprising receiving data about the items contained within the shopping carts of at least one customer waiting in a checkout line and calculating a checkout wait time for the checkout line. Identifying a second customer approaching the checkout line and determining an abandonment threshold value for the second customer. Comparing the checkout wait time to the abandonment threshold value, and when the checkout wait time is greater than or equal to the abandonment threshold value, transmitting a re-engagement coupon to the second customer.

### BACKGROUND

The present invention relates generally to the field of customer engagement, and more particularly to sending re-engagement messages to a customer when there are wait times at the checkout cashier.

Standing in a checkout waiting line in any retail store is very common and can cause a customer to abandon their purchases when the waiting lines are too long. Nobody wants to stand in a waiting line to checkout for an extended period. A customer could abandon their purchases if the waiting time for checkout is too long.

### BRIEF SUMMARY

Additional aspects and/or advantages will be set forth in part in the description which follows and, in part, will be apparent from the description, or may be learned by practice of the invention.

Embodiments of the present invention disclose a method, computer program product, and system for re-engaging a customer. A method comprising receiving data about the items contained within the shopping carts of at least one customer waiting in a checkout line and calculating a checkout wait time for the checkout line. Identifying a second customer approaching the checkout line and determining an abandonment threshold value for the second customer. Comparing the checkout wait time to the abandonment threshold value, and when the checkout wait time is greater than or equal to the abandonment threshold value, transmitting a re-engagement coupon to the second customer.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a functional block diagram illustrating a customer re-engagement processing environment, in accordance with an embodiment of the present invention.

FIG. 2 is a flowchart depicting operational steps of the calculating the wait time and customer re-engagement within the customer re-engagement processing environment of FIG. 1, in accordance with an embodiment of the present invention.

FIG. 3 is a block diagram of components of a computing device of the store server, customer mobile computing device, or other computer systems of FIG. 1, in accordance with embodiments of the present invention.

FIG. 4 depicts a cloud computing environment according to an embodiment of the present invention.

FIG. 5 depicts abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Reference will now be made in detail to the embodiments of the present invention, examples of which are illustrated in the accompanying drawings, wherein like reference numerals refer to like elements throughout. Embodiments of the invention are generally directed to a system for re-engaging customers so they will not abandon the items they intend to purchase when the wait time for checkout is long. When a customer enters a store, they can be identified as a prior customer, which allows for the customers shopping history to be retrieved, or the customer can be identified as a default customer when the customer cannot be identified as a previous customer. Once the customer has been identified, then the customer is tracked as they move around the stored to determine which items are placed in customer's shopping cart. The customer is tracked through the store by cameras, sensors on the shopping cart, an application on the customer mobile device, a handheld scanner, or any other suitable tracking means. The wait time for the checking out is continuously estimated, i.e. as customer gets in line to checkout, number of registers, cashier identity, items in the customer cart, and other factors. The system retrieves a predetermined processing time for each item within the customer's cart waiting in line. The system retrieves a cashier's efficiency rating, i.e. how efficient the cashier is at processing a customer's items, and the system determines if there are any assistants for the cashier, i.e. a bagger, since an assistant will improve checkout efficiency. The system calculates a waiting time for each customer in the checkout line based on the items in the customer's cart, the cashier, the number of registers, and/or other factors. The system calculates an overall wait time by adding up all the calculated waiting times for each customer in line. When a customer appears to be finished shopping by heading to the checkout cashier, the system determines if the overall wait time is longer than a first threshold value. The first threshold value can be determined based on the user shopping history or if the customer is a default customer then the first threshold value is a default value. When the overall waiting time for checkout is greater than or equal to the first threshold value the system tries to re-engage the customer into shopping more by sending the customer a re-engagement coupon. The re-engagement coupon will encourage the customer to continue shopping, so the customer will not have to wait in the current checkout line. The overall wait time can be shorter after the customer re-engagement opportunity, if not then the customer can be sent another re-engagement coupon. The re-engagement coupon that the system sends to the customer can be, for example, a time sensitive coupon, deal, or something similar, where the re-engagement offer is valid for the short time frame. Since the re-engagement coupon is time sensitive, i.e. only good for this shopping trip, the customer would be more likely to wait longer (i.e. if the wait time to check out has not been reduced) to check out so they can take advantage of the re-engagement coupon.

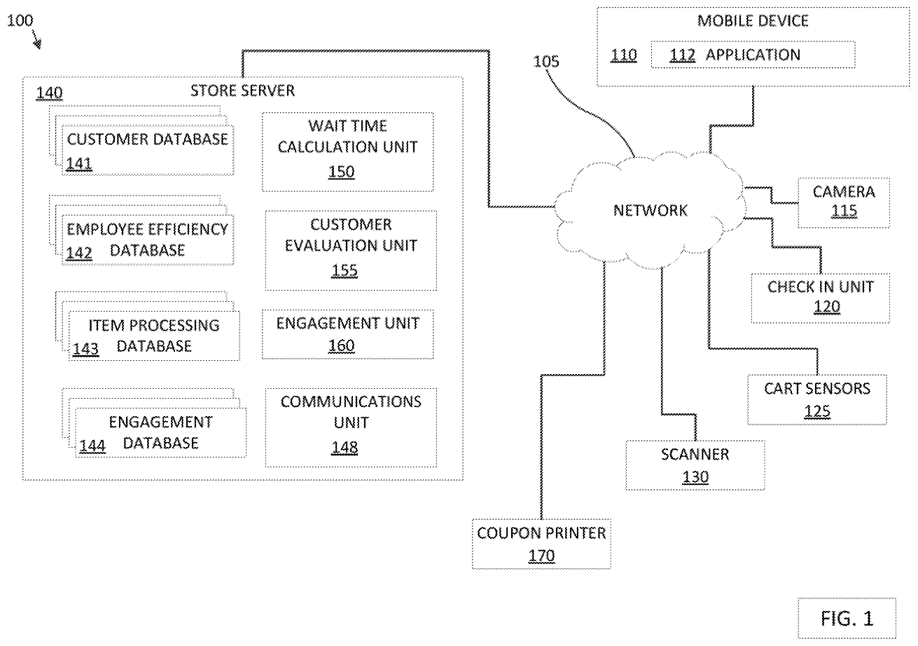

FIG. 1 is a functional block diagram illustrating a customer re-engagement processing environment 100, in accordance with an embodiment of the present invention.

Network 105 can be, for example, a local area network (LAN), a wide area network (WAN) such as the Internet, or a combination of the two, and can include wired, wireless, or fiber optic connections. In general, network 105 can be any combination of connections and protocols that will support communications between store server 140, mobile device 110, cameras 115, a check in unit 120, cart sensors 125, a scanner 130, and/or coupon printer 170.

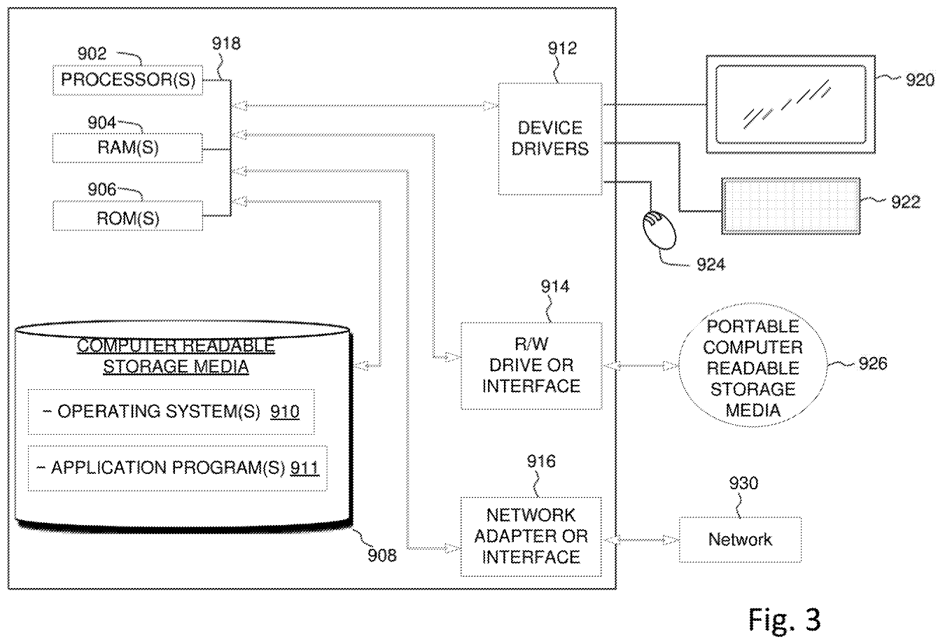

A customer can be carrying a mobile device 110, such that the mobile device 110 may be may be a laptop computer, tablet computer, netbook computer, personal computer (PC), a desktop computer, a personal digital assistant (PDA), a smart phone, or any programmable electronic device capable of communicating with store server 140 via network 105. The mobile device 110 can have an application 112 installed thereon, where the application 112 stories associated with the store. The application 112 may have different features, such as, allowing the customer to check in when entering the store, a shopping list feature that allows the customer to create a shopping list for their visit to the store, or other features. When the customer enters a store associated with the application 112, a check in window opens in the application 112 allowing the customer to check in with the store server 140 via network 105. Mobile device 110 may include internal and external hardware components, as depicted, and described in further detail with respect to FIG. 3.

Not all customers will have or want to install the application 112 associated with the store on their mobile device 110. A customer could have a rewards card they can receive from the store. Each rewards card is unique, so it allows the store to associate each rewards card with a specific customer. A check in unit 120 can be located at the store entrance that allows for a user to scan their rewards card. The store server 140 receives the scanned rewards card data from the check in unit 120 via the network 105, which allows the store server 140 to retrieve the customer data associated with the rewards card.

Cameras 115 can be mounted at different locations within the store to monitor customers entering the store and to watch which items are placed within the customer's shopping cart. The images taken by cameras 115 can be transmitted to the store server 140 via the network 105. The store server 140 can recognize the identity of the customer by receiving images of the customer's face and utilizing facial recognition software to match the facial image with images stored on the customer database 141. The cameras 115 can take images of the items that a customer places in their cart and transmit the images to the store server 140, via the network 105. The store server 140 assigns a default customer profile to the images of unidentified customers sent by the camera 115 and to track the items the default user places in his cart.

The shopping cart can have cart sensors 125 installed thereon. The cart sensor 125 can determine which items are placed within the cart and transmit that data to the store server 140 via the network 105. The items could have radio frequency identification (RFID) tags located there on and the cart sensors 125 could detect these RFIDs tags to identify items. The cart sensors 125 could also be cameras that take images of the items placed within the cart.

A store may have a kiosk that holds handheld scanners 130 located at the entrance of the store. The customer may sign out a scanner 130 from the kiosk so that the customer can scan the items that he places in his cart. The scanner 130 allows for a quicker checkout, since at checkout line the cashier only needs to connect the scanner to the register to have a full list of the items within the customer's cart. Scanner 130 may be able to connect to store server 140, via the network, to receive any coupons and to send data on the items in the cart to the store server 140.

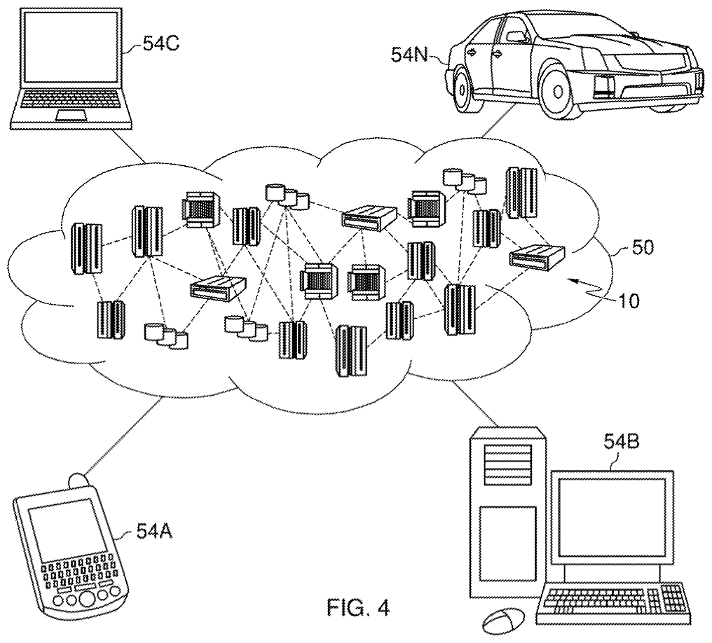

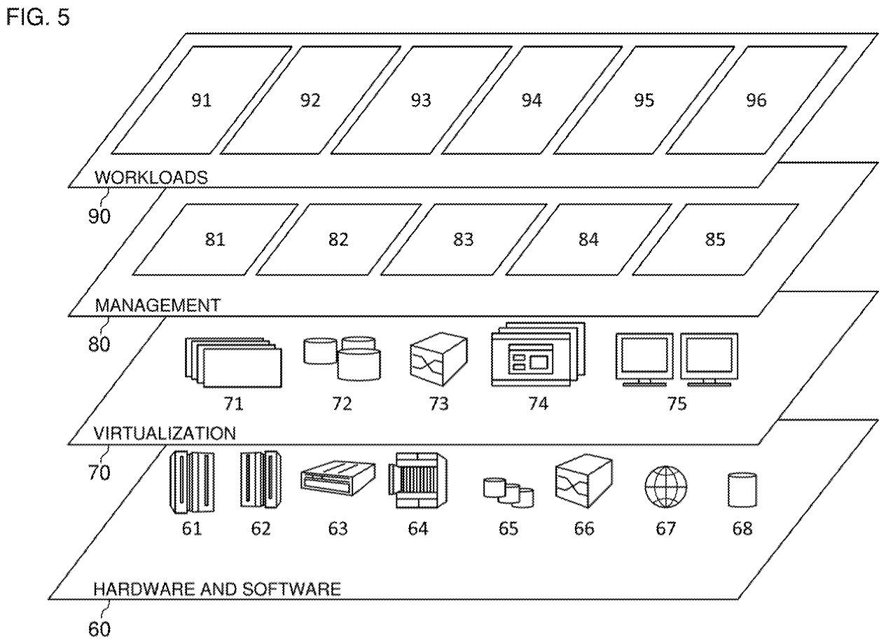

Store server 140 may include a customer database 141, an employee efficiency database 142, item processing database 143, engagement database 144, a communications unit 148, a wait time calculation unit 150, a customer evaluation unit 155, and an engagement unit 160. Store server 140 may include internal and external hardware components, as depicted, and described in further detail below with respect to FIG. 3, and operate in a cloud computing environment, as depicted in FIGS. 4 and 5.

The customer database 141 is a datastore that contains data associated with customers. The data can contain information that was provided by the customer, such as, phone number, shopping history of the customer, a picture of the customer's face, if customer has installed application 112 on their mobile device 110, or other data that was collected about the customer experience in the store.

The employee efficiency database 142 is a datastore that contains data associated with different employees of the store. The employee efficiency database 142 contains information about how efficient a cashier is at processing the items in as customer's cart when checking out the customer and information about how an assistant, i.e. a bagger, affects the cashier's efficiency rating.

The item processing database 143 is a datastore that contains time value data that relates to how long it takes an ideal cashier to checkout the items. The time value associated with each item can vary based on the size of the item, weight of the item, easy access to bar code on the item, if a hanger has to be removed, if an anti-theft device has to be removed, or other factors.

The engagement database 144 is a datastore that contains a plurality of approved re-engagement coupons. The management, marketing, or other departments of the store approves the re-engagement coupons that are available to be sent to the customer. The re-engagement coupons are time sensitive coupons that are only valid for the customer current visit to the store. The re-engagement offer can be for example, a free item, a discount on an item, free beverage, or snack from a snack counter if available, or other approved re-engagement offers.

The communications unit 148 facilitates the receiving and transmitting data by the store server 140 to and from the devices connected to the network 105.

The wait time calculation unit 150 continuously calculates the wait time for the checkout during the operation hours of the store. The wait time calculation unit 150 receives the estimated items in the shopping carts of the people in line and retrieves the processing time value for each of the items from the item processing database 143. The wait time calculation unit 150 receives information that indicates that the cashier is working alone or has assistance and the wait time calculation unit 150 retrieves the employee efficiency rating associated with the cashier from the employee efficiency database 142. The wait time calculation unit 150 adds up the process time value for each item in the customer cart to determine a preliminary wait time for the cart and the wait time calculation unit 150 applies the employee efficiency rating to the preliminary wait time to get the estimated wait time for the customer's cart. Furthermore, when the customer has been identified, the wait time calculation unit 150 can retrieve payment history (i.e., cash, credit, check) from the customer database 141 and apply a predetermined factor to the estimate waiting time based on the payment history of the identified customer. The wait time calculation unit 150 further receives the number of open checkout lanes and calculates the wait time for each separate lane.

The customer evaluation unit 155 receives data that a customer is heading for the checkout lane and receives information if the customer has been identified. The customer evaluation unit 155 determines that a customer is heading to the checkout lane by, for example, estimating if the customer has placed all the items on his shopping list in the cart, if the cart location is heading towards the checkout lane, or if the images from the camera show the cart heading to the checkout lane. When the customer has been identified, then the customer evaluation unit 155 retrieves an abandonment threshold value associated with the customer from the customer database 141. When the customer has been given a default identify, then the customer evaluation unit 155 utilizes a default abandonment threshold value. Based on the estimated wait time calculated by the wait time calculation unit 150 the customer evaluation unit determines if the estimated wait time is greater than or equal to the abandonment threshold value associated with the customer. When the estimated wait time is greater than or equal to the associated threshold then the customer is sent a re-engagement coupon. When the estimated wait time is less than the associated threshold then the customer evaluation unit 155 estimates the value of the items in the customer cart. The customer evaluation unit 155 determines a second threshold value based on the estimated value of the items in the customer cart and the customer history or default identify. When the estimated wait time is greater than or equal to the second threshold value then the customer is sent a re-engagement coupon.

The re-engagement unit 160 receives a signal from the customer evaluation unit 155 that a customer should be sent a re-engagement coupon. The re-engagement unit 160 determines which coupon should be sent to the customer via the network 105. The re-engagement unit 160 receives data about the customer from the customer database 141, the received data can include information about which items the customer has bought, which re-engagement coupons they have been previously sent, which re-engagement coupons worked and which one did not work, or other data contained in the customer database 141 that could affect which re-engagement coupon that is sent. The re-engagement unit 160 receives a list of items in the customer cart from the customer evaluation unit 155. The re-engagement unit 160 can also receive the estimated value of the customer cart from the customer evaluation unit 155 if it was calculated. Based on the received customer data the re-engagement unit 160 retrieves a coupon from the engagement database 144. For example, if the customer previously bought a certain type of item (a specific brand of cookies), then the re-engagement unit 160 can send the customer a coupon for the item. If the customer currently has items in his cart relating to a task, climbing gear, making tacos, or something else, then the re-engagement unit 160 can send a coupon relating to the task. The type of coupon that can be sent to the customer can be, for example, a free item, a discount on the item, or a buy one gets one free, or something similar. The re-engagement unit 160 evaluates any previously sent coupons to the customer to determine which type of coupon that was ignored by the customer and which type of coupon the customer took advantage of. The re-engagement unit 160 may send the customer a coupon based on the customer history, i.e. shopping history, type of items within the customer cart, which type of coupons were effective, the value of the items in the customer shopping cart, and/or other factors. The re-engagement unit 160 sends the coupon to the customer via the network 105. The customer can receive the coupon on the customer's mobile device 110, the scanner 130, or a coupon printer 170.

When a customer was given a default status then the re-engagement unit 160 is not able to send the re-engagement coupon to a customer's mobile device. The store can have multiple coupon printers 170 located around the store that are able to print different coupons. The store server 140 can track the default customer as he moves around the store by the images received from the cameras 115. The re-engagement unit 160 receives the default customer location and can send the re-engagement coupon to the closet coupon printer 170 to the default customer. To encourage a customer interaction with one of the multiple coupon printers 170, one of the coupon printers 170 can be located near the checkout line.

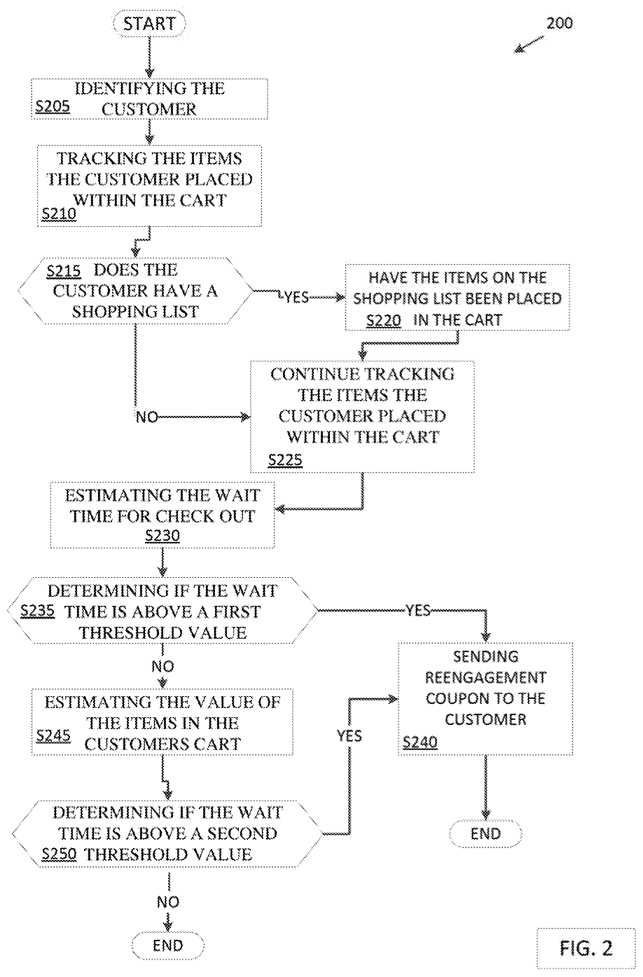

FIG. 2 is a flowchart depicting operational steps of the calculating a wait time and customer re-engagement within the customer re-engagement processing environment of FIG. 1, in accordance with an embodiment of the present invention.

The store server 140 receives data that a customer has entered the store. The customer is identified as a previous customer by the customer mobile device 110, the application 112 on the customer mobile device 110, a rewards card that was scanned by a check in unit 120, or by a portable scanner 130 being used by the customer (S205). When the customer has not been identified as a previous customer, then the customer is given a default identity (S205). The store server 140 tracks which items the customer places within his shopping cart (S210). When the customer has been identified as a previous customer by utilizing the application 112 associated with the store, then the store server 140 determines if the customer has made a shopping list on the application 112 (S215). When a shopping list was found in the application 112, then the store server 140 tracks the items placed within the shopping cart to see when the customer finds all the items on his list (S220), which allows the customer evaluation unit 155 to estimate when the customer might be heading to the checkout line. The store server continues to track the items placed within the customer cart when the customer does not have shopping list and when the customer shopping list has been completed (S225). The wait time calculation unit 150 continuously estimates the wait time for checkout (S230). The wait time calculation unit 150 retrieves the processing time for the items within a customer cart, the efficiency rating for the cashier, and any customer payment history, to estimate the wait time for checkout (S230).

The customer evaluation unit 155 receives information about the customer from the customer database 141 to see what the customer's first threshold value is, or if it the customer has been identified as a default customer, then the customer evaluation unit 155 applies a default first threshold value to the customer. The customer evaluation unit 155 determines if the wait time is greater than or equal to the first threshold value (from the customer history or the default value) associated with the customer (S235).

When the wait time is greater than or equal to the first threshold value, then the re-engagement unit 160 determines which type of coupon to send to the customer (S240). The re-engagement unit 160 receives information about the customer from the customer database 141, when the customer has been identified, as to what type of re-engagement coupons have been effective and what type of products the customer likes (S240). The re-engagement unit also receives the shopping list to see if the customer has placed all the items on their shopping list in their cart. The re-engagement unit 160 selects which coupon to send the customer based on the customer history, the customer shopping list, and/or default identify of the customer. The re-engagement unit 160 sends a coupon via the communications unit 148 to the customer mobile device 110, scanner 130, or coupon printer 170 (S240).

When the wait time is less than the first threshold value associated with the customer, then the customer evaluation unit 155 estimates the value of the items within the customer shopping cart (S245). The customer evaluation unit 155 determines a second threshold value based on the customer history or default identify, and the estimated value of the items within the customer's cart. The customer evaluation unit 155 determines if the wait time is greater than or equal to the second threshold value (S250). When the wait time is greater than or equal to the second threshold value, then the re-engagement unit 160 determines which type of coupon to send to the customer (S240). The re-engagement unit 160 receives information about the customer from the customer database 141, when the customer has been identified, as to what type of re-engagement coupons have been effective and what type of products the customer likes (S240). The re-engagement unit also receives the shopping list to see if the customer has placed all the items on their shopping list in their cart. The re-engagement unit 160 selects which coupon to send the customer based on the value of the item within the customer's cart, the customer history, the customer shopping list, and/or default identity of the customer. The re-engagement unit 160 sends a coupon via the communications unit 148 to the customer's mobile device 110, scanner 130, or coupon printer 170 (S240).

FIG. 3 depicts a block diagram of components of mobile device 110 and/or store server 140 of FIG. 1, in accordance with an embodiment of the present invention. It should be appreciated that FIG. 3 provides only an illustration of one implementation and does not imply any limitations with regard to the environments in which different embodiments may be implemented. Many modifications to the depicted environment may be made.

The mobile device 110 and/or store server 140 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. The network adapter 916 communicates with a network 930. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, for example, re-engagement unit 160 (FIG. 1), are stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

The mobile device 110 and/or store server 140 may also include a R/W drive or interface 914 to read from and write to one or more portable computer readable storage media 926. Application programs 911 on the mobile device 110 and/or store server 140 may be stored on one or more of the portable computer readable storage media 926, read via the respective R/W drive or interface 914 and loaded into the respective computer readable storage media 908.

The mobile device 110 and/or store server 140 may also include a network adapter or interface 916, such as a Transmission Control Protocol (TCP)/Internet Protocol (IP) adapter card or wireless communication adapter (such as a 4G wireless communication adapter using Orthogonal Frequency Division Multiple Access (OFDMA) technology). Application programs 911 on the mobile device 110 and/or store server 140 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

The mobile device 110 and/or store server 140 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and re-engagement unit 96.

Based on the foregoing, a computer system, method, and computer program product have been disclosed. However, numerous modifications and substitutions can be made without deviating from the scope of the present invention. Therefore, the present invention has been disclosed by way of example and not limitation.

While the invention has been shown and described with reference to certain exemplary embodiments thereof, it will be understood by those skilled in the art that various changes in form and details may be made therein without departing from the spirit and scope of the present invention as defined by the appended claims and their equivalents.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the one or more embodiment, the practical application or technical improvement over technologies found in the marketplace, or to enable others of ordinary skill in the art to understand the embodiments disclosed herein.

1. A method for re-engaging a customer, the method comprising:
receiving, by a computer, data about the items contained within the shopping carts of at least one customer waiting in a checkout line;
calculating, by the computer, a checkout wait time for the checkout line;
identifying, by the computer, a second customer approaching the checkout line;
determining, by the computer, an abandonment threshold value for the second customer wherein the abandonment threshold value is based in part on a second customer payment method history;
comparing, by the computer, the checkout wait time to the abandonment threshold value; and
when the checkout wait time is greater than or equal to the abandonment threshold value, transmitting, by the computer, a re-engagement coupon to the second customer.

2. The method of claim 1, wherein the re-engagement coupon is a time sensitive coupon only valid for the second customer current trip to the store.

3. The method of claim 1, wherein the abandonment threshold value is comprised of a first threshold value and a second threshold value.

4. The method of claim 3, wherein the first threshold value is based on a shopping history of the second customer.

5. The method of claim 4, wherein comparing, by the computer, the checkout wait time to the abandonment threshold value, further comprises comparing the checkout wait time to the first abandonment threshold value.

6. The method of claim 5, wherein when the checkout wait time is less than the first threshold value, then calculating, by the computer, an estimated value of the items within the second customer cart.

7. The method of claim 6, further comprises:
determining, by the computer, the second threshold value based on the customer shopping history and the estimated value of the items within the second customer cart; and
wherein comparing, by the computer, the checkout wait time to the abandonment threshold value, further comprises comparing the checkout wait time to the second abandonment threshold value.

8. The method of claim 1, wherein the re-engagement coupon transmitted to the customer is based on the second customer shopping history.

9. A computer program product for re-engaging a customer, the computer program product comprising:
one or more non-transitory computer-readable storage media and program instructions stored on the one or more non-transitory computer-readable storage media, the program instructions comprising:
program instructions to receive data about the items contained within the shopping carts of at least one customer waiting in a checkout line;
program instructions to calculate a checkout wait time for the checkout line;
program instructions to identify a second customer approaching the checkout line;
program instructions to determine an abandonment threshold value for the second customer, wherein the abandonment threshold value is based in part on a second customer payment method history;
program instructions to compare the checkout wait time to the abandonment threshold value; and
when the checkout wait time is greater than or equal to the abandonment threshold value, program instructions to transmit a re-engagement coupon to the second customer.

10. The computer program of claim 9, wherein the re-engagement coupon is a time sensitive coupon only valid for the second customer current trip to the store.

11. The computer program of claim 9, wherein the abandonment threshold value is comprised of a first threshold value and a second threshold value.

12. The computer program of claim 11, wherein the first threshold value is based on a shopping history of the second customer.

13. The computer program of claim 12, wherein the program instructions to compare the checkout wait time to the abandonment threshold value comprises comparing the checkout wait time to the first abandonment threshold value.

14. The computer program of claim 13 wherein when the checkout wait time is less than the first threshold value, then program instructions to calculate an estimated value of the items within the second customer cart.

15. The computer program of claim 14, further comprises:
program instruction to determine the second threshold value based on the customer shopping history and the estimated value of the items within the second customer cart; and
wherein the program instructions to compare the checkout wait time to the abandonment threshold value comprises comparing the checkout wait time to the second abandonment threshold value.

16. The computer program of claim 15, wherein the re-engagement coupon transmitted to the customer is based on the second customer shopping history.

17. A computer system for re-engaging a customer, the computer system comprising:
one or more computer processors, one or more computer-readable storage media, and program instructions stored on one or more of the computer-readable storage media for execution by at least one of the one or more processors, the program instructions comprising:
program instructions to receive data about the items contained within the shopping carts of at least one customer waiting in a checkout line;
program instructions to calculate a checkout wait time for the checkout line;
program instructions to identify a second customer approaching the checkout line;
program instructions to determine an abandonment threshold value for the second customer, wherein the abandonment threshold value is based in part on a second customer payment method history;
program instructions to compare the checkout wait time to the abandonment threshold value; and
when the checkout wait time is greater than or equal to the abandonment threshold value, program instructions to transmit a re-engagement coupon to the second customer.

18. The computer system of claim 17, wherein the re-engagement coupon is a time sensitive coupon only valid for the second customer current trip to the store.

19. The computer system of claim 17, wherein the re-engagement coupon transmitted to the customer is based on the second customer shopping history.

20. The computer system of claim 17, further comprising:
wherein the abandonment threshold value is comprised of a first threshold value and a second threshold value;
wherein the first threshold value is based on a shopping history of the second customer;
wherein the program instructions to compare the checkout wait time to the abandonment threshold value comprises comparing the checkout wait time to the first abandonment threshold value;
wherein when the checkout wait time is less than the first threshold value, then program instructions to calculate an estimated value of the items within the second customer cart;
program instruction to determine the second threshold value based on the customer shopping history and the estimated value of the items within the second customer cart; and
wherein the program instructions to compare the checkout wait time to the abandonment threshold value comprises comparing the checkout wait time to the second abandonment threshold value.
